(19) United States
(12) Patent Application Publication
(10) Pub. No.: US 2008/0126192 A1
(43) Pub. Date: May 29, 2008

(54) System and Methods for Distributing Sales of Advertisement Slots

(75) Inventors: Satya Patel, Foster City, CA (US); Susan Wojcicki, Los Altos, CA (US); Gokul Rajaram, Los Altos, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/563,385

(22) Filed: Nov. 27, 2006

(51) Int. Cl. G06Q 30/00

(52) U.S. Cl. 705/14

(57) ABSTRACT

A system and methods for distributing sales of advertisement slots involves the presentation of at least two advertisement slots, each slot from a different source. One or more potential sellers are able to select one or more advertisement slots through a user interface associated with one of the sources. A determination of the outcome of such selection is made, including whether the selection resulted in purchase by the source associated with the user interface.

### TECHNICAL FIELD

The subject matter of this document relates to advertising.

### BACKGROUND

A vast amount of data and information (referred to generally as “content”) is available via the Internet, including the world-wide web. Content can be provided from a correspondingly vast number of sources (referred to generally as “publishers”). Some of the forms which such content may take include web pages, web-sites, search results, emails and the like.

Content sources, including publishers, may wish to include web-based, on-line or other forms of electronic advertisement slots (“ads”) in association with the access to or provisioning of the content. The form, substance, and other characteristics or parameters of such advertising can be many and varied, and can be considered to create an inventory of advertisement slots e.g., advertisement products.

Content sources, e.g., publishers, may use employees and sales departments to sell their inventories of advertisement slots, either directly or indirectly, to potential advertisers, e.g. buyers. Such advertisers generally provide the advertisement slot, such as creative material, to fill the slot they purchased from the sellers. Sometimes, a publisher may enter into a suitable written agreement with another party to sell the publisher's inventory, such as with an agency or independent sales representative.

### SUMMARY

According to one implementation, two advertisement slots, each associated with a different source, are presented. It is possible to select one or more advertisement slots through a suitable user interface associated with one of the sources of such advertisement slots. A determination is made whether the selection of the advertisement slot(s) has resulted in purchase of such slot(s) by the source associated with the user interface. In one variation, there are two types of advertisement slots being presented, one type is associated with a sales commission payable to one of the sources, while the other type is not associated with such a sales commission. In still another variation, the determination of whether a selection of an advertisement slot has resulted in a purchase of such slot includes factoring in any sales commission which may be payable if such purchase is awarded to one of the sources.

An exemplary system may include a direct sales catalog of on-line advertisement slots and a distributed sales catalog of on-line advertisement slots. The catalogs are stored in a user accessible data structure, such structure including data corresponding to sales commissions. The system may include at least one computer processor programmed to present available advertisement slots from the catalogs to a given seller and update the data structure to reflect selection from the available advertisement slots.

In one variation of such system, a network is used for selectively transmitting data between potential sellers of advertisement slots and the catalogs of such advertisement slots. Sellers may access the direct and distributed sales catalogs through corresponding user interfaces.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic view of one exemplary implementation of a system for distributing sales of advertisement slots.

FIG. 2 is a schematic of one exemplary implementation of the system of FIG. 1.

FIG. 3 is a flow chart of one exemplary method associated with distributing sales of advertisement slots.

FIG. 4 is a flow chart of another exemplary method associated with distributing sales of advertisement slots.

Like reference symbols in the various drawings indicate like elements.

### DETAILED DESCRIPTION

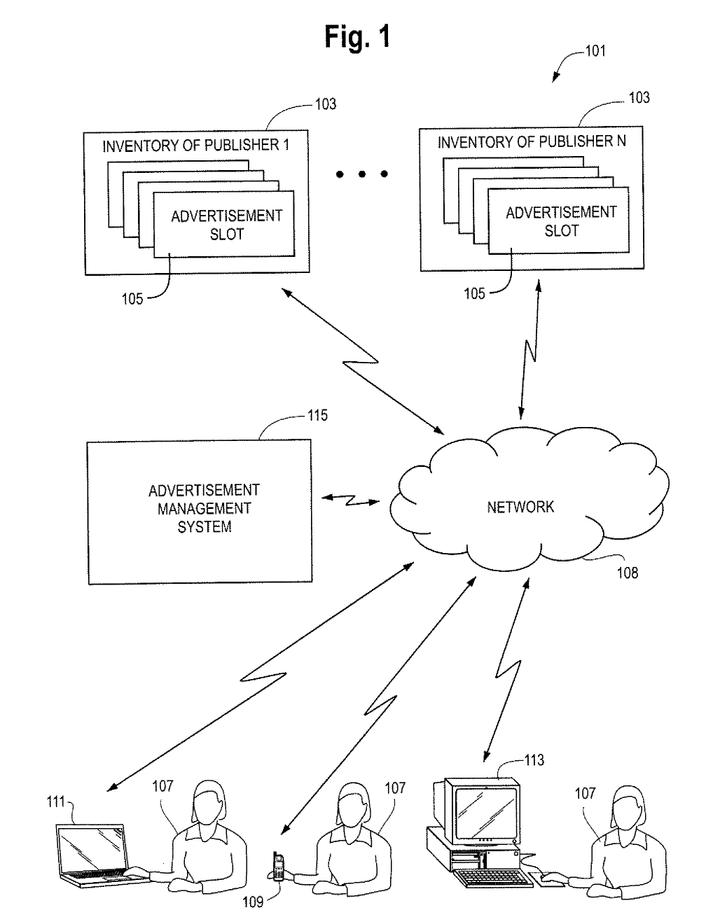

FIG. 1 is a schematic view of one exemplary implementation of a system for distributing sales of advertisement slots. Sellers access inventories 103 of advertisement slots 105 through network 108 to perform various transactions related to advertising. With system 101, sellers not only are able to include employees, sales departments, or other agents affiliated with a given content source (e.g. an on-line publisher), but also can include any number of other individuals, organizations, agents, agencies, and the like, with access to system 101, and which are unaffiliated or less related to the given content source. Sellers, as explained below, can include individuals and entities which reserve slots for, or sell slots to, advertisers and other buyers, in which case such sellers would include resellers. In addition, though, system 101 may be adapted to expose one or more inventories 103 of advertisement slots 105 directly to advertisers or other purchasers, without using sellers, such as through a self-service interface.

In one implementation, inventories 103 are associated with at least two different content sources, shown in this implementation as publisher 1 through publisher n, where n is a positive integer≧2 signifying a source of advertisement slots. The statement that two advertisement slots are associated with “different” sources does not require such sources to be separate individuals, corporations, or legal entities, but can encompass any number of distinctions between two advertisement slots or inventories, such as their association with respective divisions, slot groups, geographic areas, countries, etc. Similarly, the sources of advertisement slots may include more than just publishers, such as any number of other organizations or individuals, including advertisers, agencies, governmental groups, associations, and the like.

An advertisement slot management system 115 is implemented using suitable hardware and software and/or combination of the two to perform operations and processes related to inventories 103 and sellers 107. Among its features, advertisement slot management system 115 makes both direct and distributed sales of advertisement slots available to one or more sellers 107, as explained in more detail herein. Direct sales can include sales of advertisement slots of those sources affiliated with a seller, such as the seller's employer. Distributed sales can include sales of advertisement slots of content sources which are independent of, or more distantly related to, a seller, such as sales by a sales agent which bear a sales commission, as opposed to sales by an employee of the content source. The foregoing examples of direct and distributed sales are illustrative only, and it will be appreciated that direct and distributed sales may encompass numerous variations.

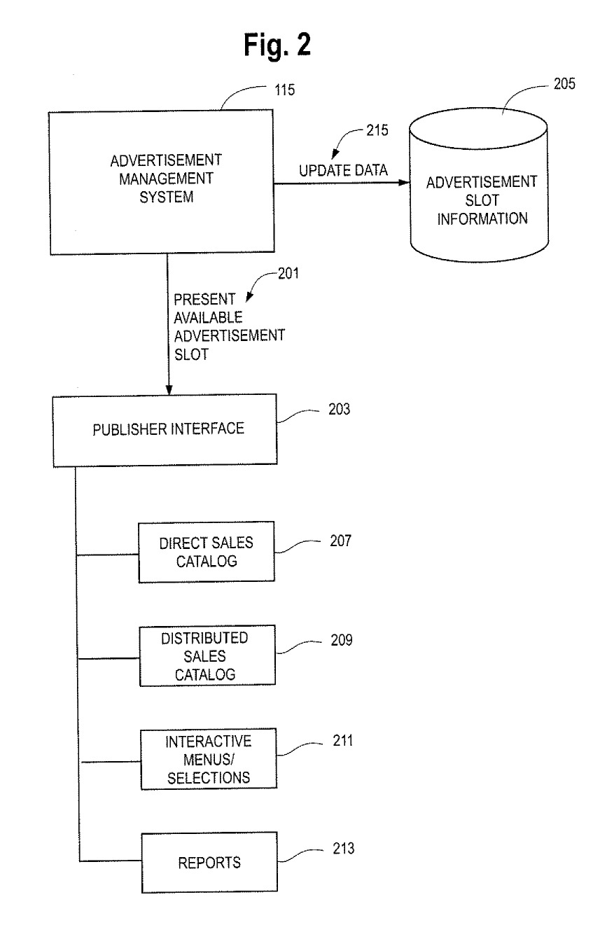

FIG. 2 is a schematic of one possible implementation of the system of FIG. 1. Advertisement slot management system 115 may interact with one or more sellers 107 (FIG. 1) to present available advertisement slots (reference 201) through a suitable publisher interface 203. Data associated with advertisement slots are stored in a suitable data structure 205. In the illustrated implementation, advertisement slot inventories from different sources are accessible or presented to a given seller as two (or more) categories, lists, or catalogs of advertisement slots. Thus, as illustrated, the seller can access a direct sales catalog 207 and a distributed sales catalog 209. As mentioned previously, one basic example of a direct sales catalog would be a publisher's inventory accessible to employees or agents of that publisher; the second catalog, the distributed sales catalog 209, can include advertisement slot inventory or inventories from other publishers or sources less related to or independent from the seller which has been presented the catalog. In the case where a given seller is affiliated with publisher 1 (FIG. 1), but unaffiliated with one or more publishers n, that seller will be presented inventory of publisher 1 identified as part of the direct catalog, and will be presented inventory other than that of publisher 1 as part of the distributed catalog.

Management system 115 determines, for a given seller accessing its system, which advertisement slots from which sources to categorize under the direct sales catalog 207 and under the distributed sales catalog 209. In one possible implementation, a publisher may opt in to a group, e.g. network, of publishers. In so doing, some or all of such publisher's advertisement slots become accessible to the other publishers through the distributed sales catalog 209. Management system 115 could include a distributed sales module for publishers to select, which would give them access to other publishers who have similarly opted in, along with any inventory designated for the group, as explained below.

System 115 may permit publishers to designate their inventory between direct and distributed categories in any number of ways, thereby giving publishers the flexibility to tailor ad campaigns to meet corresponding objectives. A publisher may designate its inventory to the distributed sales category at certain times, with certain commissions, or with certain pricing requirements, among other criteria. So, as a further example, if a publisher wishes its own sellers to have first crack at selling certain inventory, a publisher may delay providing such inventory to the distributed sales category. After a certain period of time for its sellers to place advertisement slots, the publisher may designate its unsold or excess inventory to system 115 for distributed sales.

Another variation would be to designate some or all of a publisher's inventory to the distributed sales category in parallel with or instead of the direct sales catalog. Publishers with little or no sales personnel may elect this arrangement in order to expose the inventory to the most potential sellers in hopes of selling the maximum amount of inventory at the maximum price. When this approach involves listing or designating some or all of a publisher's inventory to both the direct and distributed categories, it pits a publisher's sellers against those of other publishers in the network or group.

Still other variations in the listing or designation of inventory to categories are possible, including having more than two catalogs or categories to which publishers of the group may designate slots. So, for example, categories and catalogs may be established according to any number of characteristics of the advertisement slots available from the publishers. Such characteristics include the identity or quality of the publisher corresponding to the advertisement slot, the industry or market vertical associated with one or more publishers, the particular slotting, advertisement slot frequency, and other parameters related to advertisement slot display, as well as cataloging or categorizing according to type of advertisement slot. The presentation of such catalogs may be varied to suit the particular user interface 203. In the case of a screen display of catalogs, advertisement slots may be sorted or otherwise filtered according to one or more characteristics.

In competitive selling situations, system 115 may include tools or other suitable programming to determine which sale(s) by which seller(s) optimize revenues or achieve other objectives. Such determinations can be part of determining which seller is awarded the sale of the corresponding advertisement slot.

System 115 makes use of selective data stored as advertisement slot information in data structure 205. Such data may include sales commissions associated with advertisement slots. In one implementation, publishers assign a commission to advertisement slots to be associated with the distributed sales category. The commission provides an incentive for sellers unaffiliated with the publisher to attempt to sell the advertisement slot, since the seller would be credited with a commission. Similarly, points, credits, rewards, or any number of other incentives may be provided for slots in system 115, including those in the distributed sales catalog, and the corresponding data may be accessed by or stored in system 115 for use in processing sales of advertisement slots.

Advertisement slot information may also include whether the advertisement slot is to be sold as a reservation, bid on through auction, or purchased via any number of other variations related thereto. Thus, when there is competition for selling advertisement slots, such as in auction-based or other multiple-seller settings, suitable programming may determine the purchaser of the advertisement slots after factoring in any commissions or other costs associated with potential sellers. In the case of a fixed price or reservation-based sale, if multiple sellers have sold the same advertisement slot at the same price, system 115 may include suitable programming to evaluate the different sales or sellers and break the tie. Alternately, or in addition, system 115 may present the multiple sellers to the publisher or other entity associated with the advertisement slot in question for a determination of which seller shall be awarded the sale. Such determination may be automatic or manual, based on any number of parameters, such as the “fit” of the advertisement slot to the publisher's content, loyalty or ranking of the seller, etc.

Transactions, including input, output, and processing related to sellers and system 115, may be facilitated through suitable interactive menus and selection options 211, including any suitable graphic or aural/voice user interfaces, as well as suitable machine interfaces. System 115 may interact with sellers 107 over network 108 (FIG. 1) through a suitable user interface associated with a corresponding electronic device, such as laptop 111, PDA 109, or other computer 113. System 115 updates data (reference 215) in data structure 205 as appropriate as a result of such transactions. In the case of auction or other competitions for available advertisement slots, advertisement slot information may be stored in data structures accessible to one or more servers associated with an on-line service provider or portal, rather than with one of the content sources. Any number of administrative features can be made available to sellers, including reports 213, such as those relating to inventory, volumes, profitability, click-through rates, campaign management, and the like.

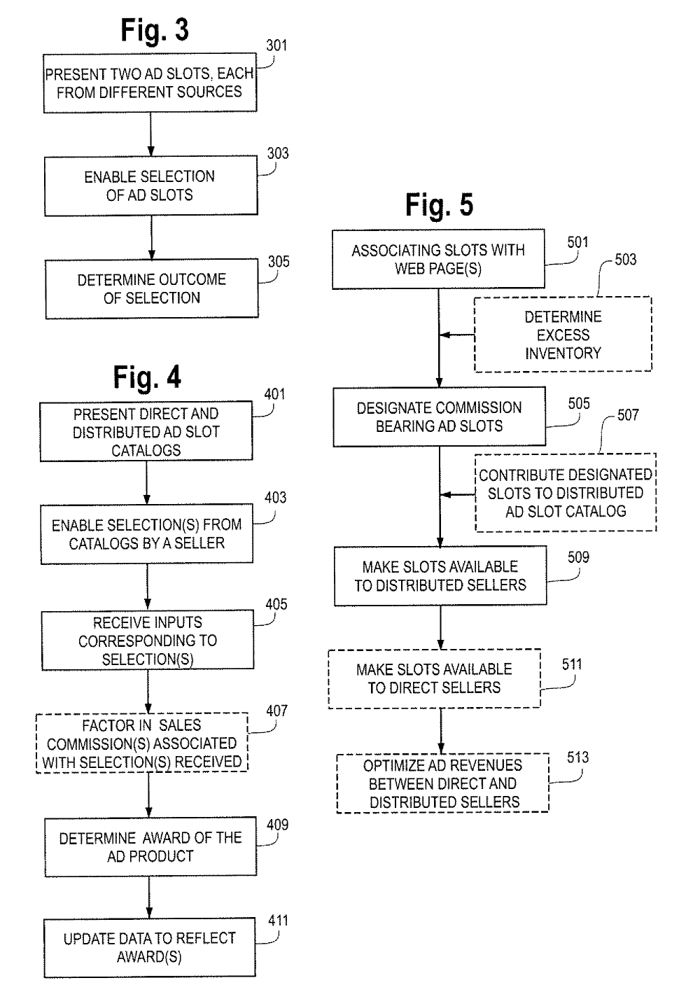

FIG. 3 is a flow chart of one method associated with distributing sales of advertisement slots. Available advertisement slots are presented to at least one potential seller. In this implementation, at least two advertisement slots, each from a different source, are presented (block 301). The presentation may take into account any affiliation of the seller with one of the sources, and may list or otherwise indicate to the seller whether an advertisement slot is in the direct, distributed, or other defined category. The seller is able to select one or more advertisement slots such as would occur if the seller sold the slot to an advertiser or placed a bid on such slot. Suitable programming makes a determination of an outcome of the selection, such as which seller shall be awarded the purchase transaction for the selected advertisement slot.

In this implementation, the seller is awarded with the purchase of the advertisement slot, which can include a reservation of such slot for one or more advertisers. The seller thus may be acting as an agent or employee of one or more advertisers who provide the advertisement to fill the advertisement slot purchased by the above-described method. The seller may also be a reseller of the purchased advertisement slot. Still other relationships are possible between the seller, the advertiser, e.g. buyer, and the provider of the advertisement for the slots, including the possibility that the seller itself is the advertiser and provides the advertisement slot.

The sellers' selections of advertisement slots may occur in any number of processes associated with advertising ad campaigns. So, for example, a seller may be bidding for advertisement slots, in which case an auction may be involved in determining the outcome of the selection. Inventory may also be reserved, purchased outright, or otherwise allocated to a seller consistent with ad campaigns, publisher's guidelines, and a variety of other parameters.

FIG. 4 is a flow chart of another method associated with distributing sales of advertisement slots from different sources. According to this method, advertisement slots are presented so as that a given seller is able to identify which of them are direct, or which are distributed. Content sources include on-line content publishers. Presenting the different catalogs of advertisement slots may involve accessing corresponding data over a network and displaying such data on a graphical user interface. The ads can be grouped into direct and distributed catalogs and suitably displayed or otherwise presented (block 401). The direct ads which are presented to the given seller include advertisement slots from a content source associated with that seller. The distributed ads presented to the given seller include advertisement slots from one or more content sources other than that or those associated with the seller.

Once the catalogs are presented to the given seller, the seller is able to select one or more advertisement slots from either category (or both) (block 403). Corresponding inputs are received (block 405). The form of such input will depend on the particular advertisement slot or interface. So, for example, in the case of a fixed reservation at a fixed price, an indication of purchase will be inputted. In the case of competitive bidding or auction, a not-to-exceed value may be inputted. The not-to-exceed value may be a maximum cost per thousand advertisement impressions (max CPM), with the highest max CPM bid by a seller potentially constituting the highest bid, depending on the amount of commission or costs payable, if any. In other words, in the event sales commissions are associated with advertisement slots, such as may be the case for inventory in the distributed sales catalog, sales commissions may be factored in during processing of the selection(s) (block 407).

A determination of which seller shall be awarded the ad slot is made (block 409). If there are multiple bids on, or multiple sales of, the same advertisement slot, the determination may include awarding the purchase of the advertisement slot to the highest bidder, to the seller which maximizes revenue (or lowers liability), or based on any number of other parameters. Data is suitably updated to reflect the award(s) (block 411).

FIG. 5 is a flowchart of another method associated with distributing sales of advertisement slots. A content source, such as an on-line publisher, is one possible entity which may be involved in some or all of the aspects of this method. On-line content, such as web pages, is associated with advertisement slots (block 501). For example, a content publisher may divide up its website into advertisement slots, which slots are available to sellers to reserve for advertisers to place advertisements therein. In one variation, a determination is made whether there is any excess inventory of advertisement slots (block 503). Some or all the advertisement slots, whether from excess inventory or by association with on-line content, may be designated as having a sales commission (block 505). The designated advertisement slots can be contributed or suitably transmitted to a distributed catalog of advertisement slots (block 507). The advertisement slots, along with associated commissions, are made available to distributed sellers, that is, sellers other than those affiliated with the on-line advertisement slots (block 509). In one variation, some or all of these advertisement slots, or even other advertisement slots, may be made available to direct sellers, that is, sellers affiliated with the on-line advertisement slots (block 511). In such variation, revenues from sales of the advertisement slots are optimized as between direct and distributed sellers.

Referring again to FIGS. 1 and 2, system 115 is one suitable system through which the above-described method may be implemented. System 115 and its associated programming may be implemented through one or more computer processors. Some or all of the features of system 115 may be stand-alone applications, or can be parts of larger advertisement slot management systems and associated applications. Publisher interface 203 may be associated with suitable applications or tools, such as Google ADSENSE. System 115 may interact with other applications of sellers, publishers, advertisers, and the like to provide the features discussed herein or to provide additional, related features.

In one implementation, system 115, including its distributed sales module discussed previously, comprises a web-based application associated with one or more servers or similarly networked computers. Such a web-based application may be associated with an on-line service provider, search engine, portal, or other web-related business. Alternately, or in addition, advertisement slot management system 115 may be associated primarily with a single publisher of on-line content, which publisher then makes system 115 available to other content sources.

It will be understood that still further modifications may be made without departing from the spirit and scope of the invention. Accordingly, other implementations are within the scope of the following claims.

1. A method comprising:
presenting at least two advertisement slots, each slot from a different source;
enabling selection of the advertisement slots through a user interface associated with one of the sources; and
determining an outcome of the selection, including whether the selection resulted in purchase by the source associated with the user interface.

2. The method of claim 1, wherein presenting the advertisement slots includes presenting two types of advertisement slots, one type with a sales commission payable to one of the sources and the other type without a sales commission.

3. The method of claim 2, wherein the sources are on-line content publishers, and wherein presenting the advertisement slots includes associating the advertisement slots without commission with a first one of the on-line content publishers, and associating the advertisement slots with commissions with at least one, on-line content publisher other than the first content publisher.

4. The method of claim 3, wherein presenting the advertisement slots includes accessing data corresponding to the advertisement slots over a network and displaying data related to available advertisement slots on the user interface; and wherein enabling selection of the advertisement slots includes receiving user input corresponding to the selection; and further comprising updating the data to reflect the selection.

5. The method of claim 2, further including determining whether a user associated with one of the Sources purchased an advertisement slot including factoring in the sales commission payable to another one of the sources.

6. The method of claim 5, further comprising:
enabling at least one of the sources to associate an advertisement slot with a corresponding sales commission; and
determining a purchaser of the advertisement slot as between the sources including optimizing revenue to the one source.

7. A system comprising:
a direct sales catalog of on-line advertisement slots and a distributed sales catalog of on-line advertisement slots, the catalogs stored in a user-accessible data structure, the data structure including data corresponding to sales commissions; and
at least one computer processor programmed to:
present available advertisement slots from the catalogs; and
update the data structure to reflect selection from the available advertisement slots.

8. The system of claim 7, wherein the data structure includes further data corresponding to publishers associated with the on-line advertisement slots, advertisement slot information, and cost; and further comprising:
a network for selectively transmitting the data; and
at least one user interface for presenting the transmitted data.

9. The system of claim 7, wherein the processor is further programmed to:receive input corresponding to a selection of one of the available advertisement slots; and
determine a purchaser of the selected advertisement slot.

10. The system of claim 9, wherein the processor is programmed to enable multiple selection options for available advertisement slots, the options including a reservation and a bid.

11. The system of claim 10, wherein the options enabled by the processor further include an auction-based reservation.

12. The system of claim 7, wherein the processor is programmed to
enable receipt of a bid for a selected one of the available on-line advertisement slots; and
determine a purchaser including determining a winning bid for a selected on-line advertisement slot.

13. The system of claim 7, wherein the distributed sales catalog and the direct sales catalog include at least one identical advertisement slot, the identical advertisement slot being associated with a corresponding sales commission in the distributed sales catalog, and wherein the processor is programmed to determine a purchaser of the identical advertisement slot as between selection from the distributed catalog by a first user and selection from the direct catalog by a second user different from the first user.

14. A method comprising:
associating advertisement slots with content available over a network;
designating at least a portion of the advertisement slots as subject to commission payment; and
enabling access to the designated advertisement slots by distributed sellers.

15. The method of claim 14, in which the content includes web pages and the network includes the world-wide web.

16. The method of claim 14, further including enabling access to direct sellers of the advertisement slots.

17. The method of claim 16, further including defining a First advertisement slot catalog and enabling access to the first catalog by distributed sellers, and defining a second advertisement slot catalog, and enabling access to the second catalog by direct sales representatives.

18. The method of claim 14, further including providing excess inventory of advertisement slots for access by the distributed sellers.

19. A method comprising:
presenting at least two advertisement slots, each slot from a different source;
enabling selection of the advertisement slots through a user interface; and
determining an outcome of the selection, including whether the selection resulted in purchase of the advertisement slot.

20. The method of claim 19, wherein presenting the advertisement slots includes presenting two types of advertisement slots, one type with a sales commission payable to one of the sources and the other type without a sales commission.

21. The method of claim 20, wherein the sources are on-line content publishers, and wherein presenting the advertisement slots includes associating the advertisement slots without commission with a first one of the on-line content publishers, and associating the advertisement slots with commissions with at least one, on-line content publisher other than the first content publisher.

22. The method of claim 21, wherein presenting the advertisement slots includes accessing data corresponding to the advertisement slots over a network and displaying data related to available advertisement slots on the user interface; and wherein enabling selection of the advertisement slots includes receiving user input corresponding to the selection; and further comprising updating the data to reflect the selection.

23. The method of claim 20, further including determining whether a user associated with one of the sources purchased an advertisement slot including factoring in the sales commission payable to another one of the sources.

24. The method of claim 23, further comprising:
enabling at least one of the sources to associate an advertisement slot with a corresponding sales commission; and
determining a purchaser of the advertisement slot as between the sources including optimizing revenue to the one source.
